(19) United States
(12) Patent Application Publication
(10) Pub. No.: US 2021/0096298 A1
(43) Pub. Date: Apr. 1, 2021

(54) OPTICAL WAVEGUIDE CIRCUIT SUBSTRATE AND MANUFACTURING METHOD THEREOF

(71) Applicant: Subtron Technology Co., Ltd., Hsinchu County (TW)

(72) Inventors: Pei-Wei Wang, Taipei City (TW); Cheng-Ping Yang, Taipei City (TW); Chiao-Yi Cheng, Hsinchu County (TW)

(73) Assignee: Subtron Technology Co., Ltd., Hsinchu County (TW)

(21) Appl. No.: 16/878,624

(22) Filed: May 20, 2020

(30) Foreign Application Priority Data
Sep. 26, 2019 (TW) 108134799

(51) Int. Cl. G02B 6/12; G02B 6/036; F21V 8/00

(52) U.S. Cl. CPC G02B 6/12; G02B 6/0065; G02B 6/036

(57) ABSTRACT

An optical waveguide circuit substrate includes a circuit board and an optical waveguide structure disposed on a lower surface of the circuit board. A plurality of pads are disposed on an upper surface of the circuit board. The optical waveguide structure includes a first cladding layer, a second cladding layer, a core layer and a reflective layer. The core layer has an imprinted opening of which an aperture gradually increases from the first cladding layer to the second cladding layer. A first portion of the second cladding layer fills the imprinted opening and has a connection surface. The reflective layer is located between the core layer and the first portion, and an angle between the reflective layer and the connection surface is in a range from 44 degrees to 46 degrees. An orthographic projection of the reflective layer on the upper surface is located between the pads.

### CROSS-REFERENCE TO RELATED APPLICATION

This application claims the priority benefit of Taiwan application serial no. 108134799, filed on Sep. 26, 2019. The entirety of the above-mentioned patent application is hereby incorporated by reference herein and made a part of this specification.

### BACKGROUND OF THE INVENTION

### Field of the Invention

The invention generally relates to a circuit substrate and a manufacturing method thereof, and in particular, to an optical waveguide circuit substrate and a manufacturing method thereof.

### Description of Related Art

In general, with the increase of information capacity, light interconnection technologies of optical signals are actively developed in the field of information processing. In the current circuit substrate technology, a circuit substrate having an optical waveguide structure has been developed at present. This circuit substrate may serve as an optical transmission path to transmit an optical signal.

At present, a manufacturing method of such a circuit substrate having an optical waveguide structure usually involves forming an opening in a core layer via a laser process, generating total reflection based on a refractive index difference between air and the core layer and then transmitting the optical signal outward. However, it is difficult to use the laser process to form an opening at a specific angle of 45 degrees for generating the total reflection, and higher production costs are needed.

### SUMMARY OF THE INVENTION

The invention provides an optical waveguide circuit substrate and a manufacturing method thereof, which require a simple manufacturing process, have a high yield and can reduce the manufacturing costs.

The optical waveguide circuit substrate of the invention includes a circuit board and an optical waveguide structure. The circuit board has an upper surface and a lower surface opposite to each other, and a plurality of pads disposed on the upper surface. The optical waveguide structure is disposed on the circuit board and located on the lower surface. The optical waveguide structure includes a first cladding layer, a second cladding layer, a core layer and a reflective layer. The second cladding layer includes a first portion and a second portion. The core layer is located between the first cladding layer and the second cladding layer and has an imprinted opening. The first cladding layer is located between the circuit board and the core layer. An aperture of the imprinted opening gradually increases from the first cladding layer to the second cladding layer. The first portion of the second cladding layer fills the imprinted opening and has a connection surface. The second portion of the second cladding layer is in contact with the connection surface and covers a bottom surface of the core layer. The connection surface is flush with the bottom surface. The reflective layer is located between the core layer and the first portion of the second cladding layer. An angle between the reflective layer and the connection surface is in a range from 44 degrees to 46 degrees, and an orthographic projection of the reflective layer on the upper surface of the circuit board is located between the plurality of pads.

A manufacturing method of an optical waveguide circuit substrate of the invention includes: providing a circuit board, the circuit board having an upper surface and a lower surface opposite to each other and a plurality of pads disposed on the upper surface; forming a first cladding layer on the lower surface of the circuit board; forming a core layer on the first cladding layer; forming an imprinted opening on the core layer by imprinting, an aperture of the imprinted opening gradually increasing from the first cladding layer to a direction away from the first cladding layer; forming a reflective layer on a sidewall of the imprinted opening, an orthographic projection of the reflective layer on the upper surface of the circuit board being located between the plurality of pads; and forming a second cladding layer on the core layer, the second cladding layer including a first portion and a second portion, the first portion filling the imprinted opening and having a connection surface, the second portion being in contact with the connection surface and covering a bottom surface of the core layer, and the connection surface being flush with the bottom surface. The reflective layer is located between the core layer and the first portion of the second cladding layer, and an angle between the reflective layer and the connection surface is in a range from 44 degrees to 46 degrees.

In an embodiment of the invention, the circuit board includes at least one insulating layer and at least one patterned circuit layer. The at least one patterned circuit layer includes a plurality of conducting circuits and the plurality of pads. The insulating layer is located between the patterned circuit layer and the optical waveguide structure.

In an embodiment of the invention, the circuit board further includes a solder resist layer and a surface treatment layer. The solder resist layer clads the plurality of conducting circuits. The surface treatment layer clads the plurality of pads.

In an embodiment of the invention, the circuit board further includes a supporting layer. The supporting layer is disposed between the insulating layer and the optical waveguide structure, and a first side of the supporting layer is retracted by a distance relative to a second side of the first cladding layer.

In an embodiment of the invention, the supporting layer has an opening. An orthographic projection of the opening on the upper surface is located between the plurality of pads.

In an embodiment of the invention, the first cladding layer fills the opening and covers part of the insulating layer.

In an embodiment of the invention, the orthographic projection of the opening on the upper surface and an orthographic projection of the imprinted opening on the upper surface partially overlap.

In an embodiment of the invention, an optical refractive index of the first cladding layer and an optical refractive index of the second cladding layer are different from an optical refractive index of the core layer.

In an embodiment of the invention, part of the second cladding layer is in direct contact with the first cladding layer.

In an embodiment of the invention, a cross-sectional shape of the first portion of the second cladding layer includes an isosceles trapezoid.

Based on the above, the first portion of the second cladding layer of the optical waveguide circuit substrate of the invention fills the imprinted opening of the first cladding layer, the reflective layer is located between the core layer and the first portion of the second cladding layer, and the angle between the reflective layer and the connection surface is in a range from 44 degrees to 46 degrees. Therefore, an optical signal subsequently entering via a space between the pads of the circuit board may be transmitted outward through total reflection in the core layer via the reflective layer. In addition, because the imprinted opening is manufactured by imprinting in the invention, compared with an opening formed by a conventional laser process, the optical waveguide circuit substrate of the invention is easy to manufacture and high in yield and can effectively reduce the production costs.

To make the features and advantages of the invention clear and easy to understand, the following gives a detailed description of embodiments with reference to accompanying drawings.

### BRIEF DESCRIPTION OF THE DRAWINGS

FIG. 1 illustrates a schematic cross-sectional diagram of an optical waveguide circuit substrate according to an embodiment of the invention.

FIG. 2A to FIG. 2D illustrate schematic cross-sectional diagrams of a manufacturing method of the optical waveguide circuit substrate of FIG. 1.

### DESCRIPTION OF THE EMBODIMENTS

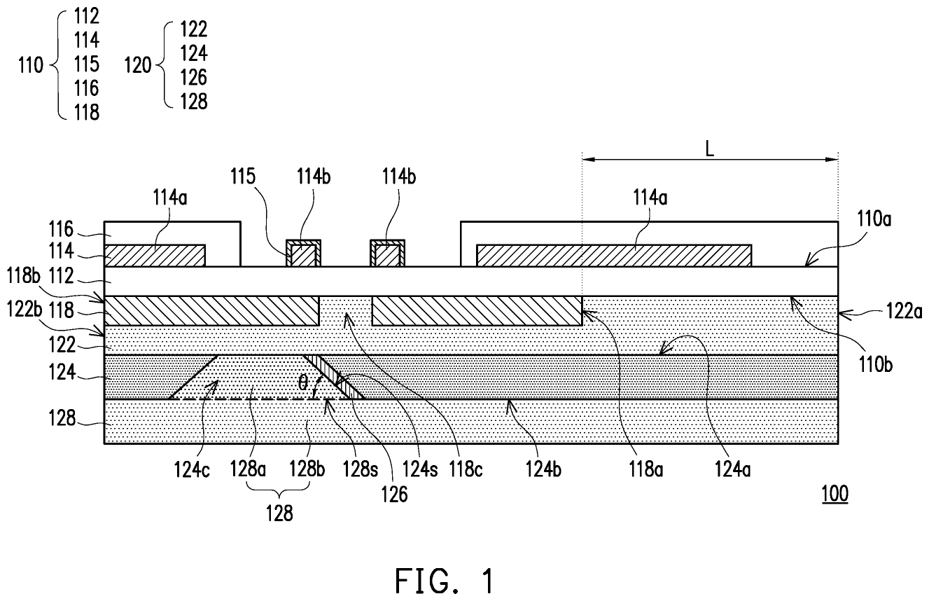

FIG. 1 illustrates a schematic cross-sectional diagram of an optical waveguide circuit substrate according to an embodiment of the invention. Referring to FIG. 1, in the present embodiment, the optical waveguide circuit substrate 100 includes a circuit board 110 and an optical waveguide structure 120. The optical waveguide structure 120 includes a first cladding layer 122, a core layer 124, a reflective layer 126 and a second cladding layer 128.

In detail, the circuit board 110 of the present embodiment has an upper surface 110a and a lower surface 110b opposite to each other and a plurality of pads 114b disposed on the upper surface 110a. Furthermore, the circuit board 110 of the present embodiment may include at least one insulating layer (one insulating layer 112 is schematically illustrated in FIG. 1) and at least one patterned circuit layer (one patterned circuit layer 114 is schematically illustrated in FIG. 1). A material of the insulating layer 112 is, for example, polyimide. A material of the patterned circuit layer 114 is, for example, copper. The insulating layer 112 has the upper surface 110a and the lower surface 110b, and the insulating layer 112 is located between the patterned circuit layer 114 and the optical waveguide structure 120. The patterned circuit layer 114 is located on the upper surface 110a of the insulating layer 112, and includes a plurality of conducting circuits 114a and the plurality of pads 114b. It should be noted that the invention does not limit the number of the insulating layers 112 and the number of the patterned circuit layers 114, which may depend on the design requirements of the actual circuit board 110.

Furthermore, in order to effectively maintain the characteristics of the patterned circuit layer 114, the circuit board 110 of the present embodiment further includes a surface treatment layer 115 and a solder resist layer 116. The surface treatment layer 115 clads the pads 114b. A material of the surface treatment layer 115 is, for example, nickel, gold, silver, nickel gold, nickel silver, nickel palladium or other suitable metal materials. The solder resist layer 116 clads the conducting circuits 114a to prevent oxidation of the conducting circuits 114a. A material of the solder resist layer 116 is, for example, green lacquer. In addition, in order to improve the structural strength, the circuit board 110 of the present embodiment further includes a supporting layer 118. The supporting layer 118 is disposed between the insulating layer 112 and the optical waveguide structure 120, and a first side 118a of the supporting layer 118 is retracted by a distance L relative to a second side 122a of the first cladding layer 122. As shown in FIG. 1, the supporting layer 118 of the present embodiment further has an opening 118c. An orthographic projection of the opening 118c on the upper surface 110a is located between the pads 114b. The circuit board 110 may be, for example, a flexible circuit board, and a material of the supporting layer 118 is, for example, copper, but is not limited thereto.

Referring to FIG. 1 again, the optical waveguide structure 120 of the present embodiment includes the first cladding layer 122, the core layer 124, and the second cladding layer 128 that are stacked on the circuit board 110 in sequence and located on the lower surface 110b, and the reflective layer 126 that is located between the core layer 124 and the second cladding layer 128. An optical refractive index of the first cladding layer 122 and an optical refractive index of the second cladding layer 128 are different from an optical refractive index of the core layer 124.

In detail, the first cladding layer 122 of the optical waveguide structure 120 fills the opening 118c of the supporting layer 118, and covers part of the insulating layer 112. Specifically, a side 118b of the supporting layer 118 opposite to the first side 118a is flush with a side 122b of the first cladding layer 122 opposite to the second side 122a. The first cladding layer 122 covers the first side 118a of the supporting layer 118 and is in direct contact with part of the insulating layer 112.

Furthermore, the core layer 124 of the optical waveguide structure 120 is disposed on the first cladding layer 122, and the first cladding layer 122 is located between the insulating layer 112 and the core layer 124. In detail, the core layer 124 has an imprinted opening 124c of which an aperture gradually increases from the first cladding layer 122 to the second cladding layer 128. That is, the aperture of the imprinted opening 124c gradually increases from the first cladding layer 122 to a direction away from the first cladding layer 122. In other words, the aperture of the imprinted opening 124c gradually increases from a top surface 124a of the core layer 124 to a bottom surface 124b of the core layer 124. In an embodiment, the orthographic projection of the opening 118c of the supporting layer 118 on the upper surface 110a and an orthographic projection of the imprinted opening 124c on the upper surface 110a partially overlap.

In addition, the second cladding layer 128 of the optical waveguide structure 120 is disposed on the first cladding layer 122. The core layer 124 is located between the first cladding layer 122 and the second cladding layer 128. In an embodiment, the second cladding layer 128 is in direct contact with the first cladding layer 122. Furthermore, the second cladding layer 128 includes a first portion 128a and a second portion 128b that are connected to each other. The first portion 128a of the second cladding layer 128 fills the imprinted opening 124c of the core layer 124. There is a connection surface 128s between the first portion 128a and the second portion 128b. The connection surface 128s is flush with the bottom surface 124b of the core layer 124. The second portion 128b of the second cladding layer 128 is in contact with the connection surface 128s and covers the bottom surface 124b of the core layer 124. In an embodiment, a cross-sectional shape of the first portion 128a of the second cladding layer 128 is, for example, an isosceles trapezoid, but is not limited thereto.

Referring to FIG. 1 again, the reflective layer 126 of the optical waveguide structure 120 of the present embodiment is located between the core layer 124 and the first portion 128a of the second cladding layer 128. In detail, an angle θ between the reflective layer 126 and the connection surface 128s is, for example, in a range from 44 degrees to 46 degrees, preferably 45 degrees. The orthographic projection of the reflective layer 126 on the upper surface 110a of the circuit board 110 is located between the pads 114b. Furthermore, the reflective layer 126 is located on a sidewall 124s, close to the opening 118c of the supporting layer 118, of the imprinted opening 124c of the core layer 124, and the reflective layer 126 faces the opening 118c of the supporting layer 118.

In an embodiment, a laser diode (not illustrated) may be disposed on the optical waveguide circuit substrate 100 of the present embodiment. The laser diode may be electrically connected to the pads 114b of the circuit board 110 by flip chip to generate an optical signal. The optical signal sequentially passes through the pads 114b, the insulating layer 112, the opening 118c of the supporting layer 118 and the first cladding layer 122, then generates total reflection in the core layer 124 via the reflective layer 126, and is transmitted to outside. The path that the optical signal passes through may be known as an optical transmission path. In an embodiment, after the optical signal leaves the core layer 124, an optical fiber or a photodetector may be connected to convert the optical signal into an electrical signal, and the electrical signal may enter another electronic device, or the electrical signal may be transmitted again to the laser diode, so that the electrical signal is reconverted into the optical signal and returns to the optical waveguide circuit substrate 100.

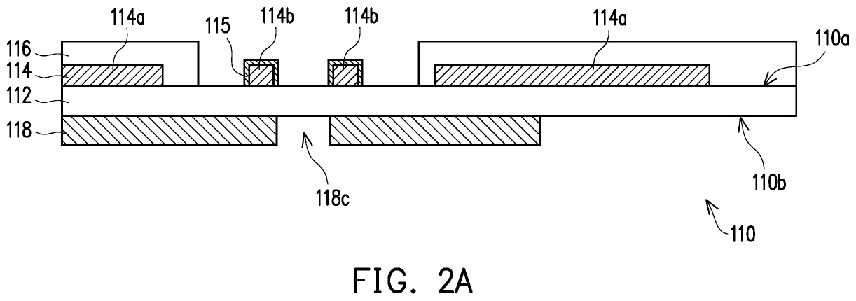

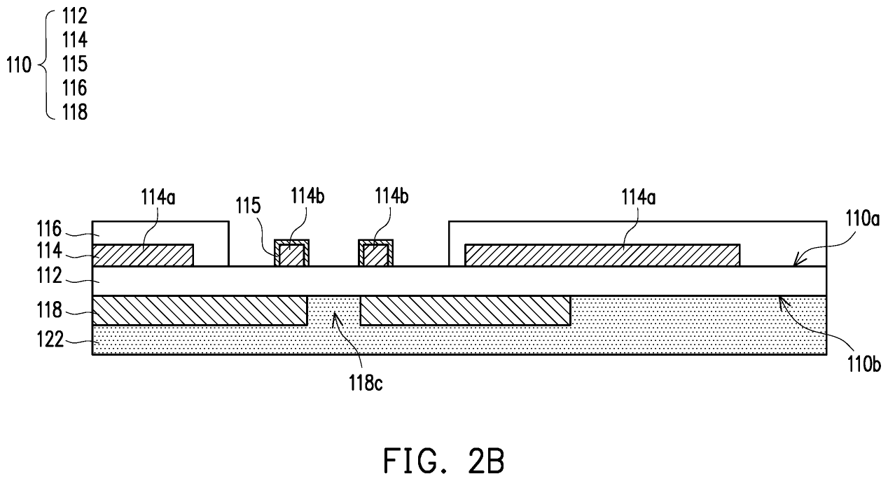

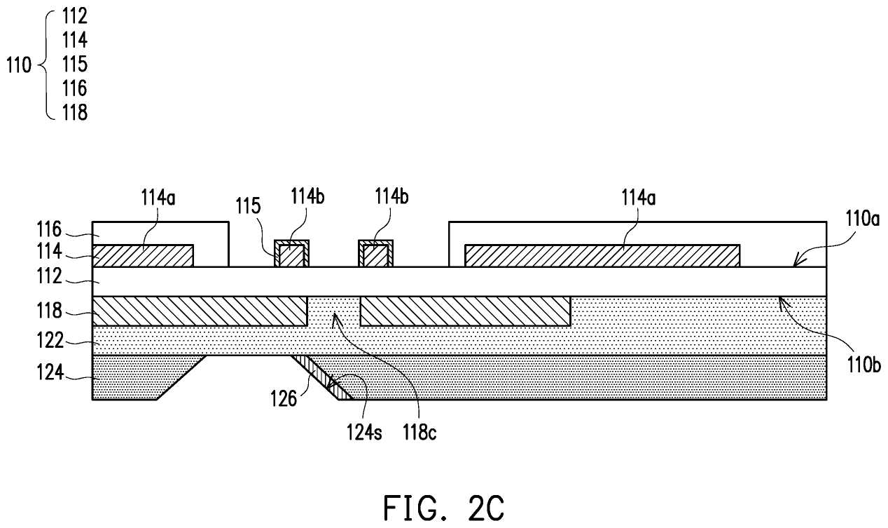

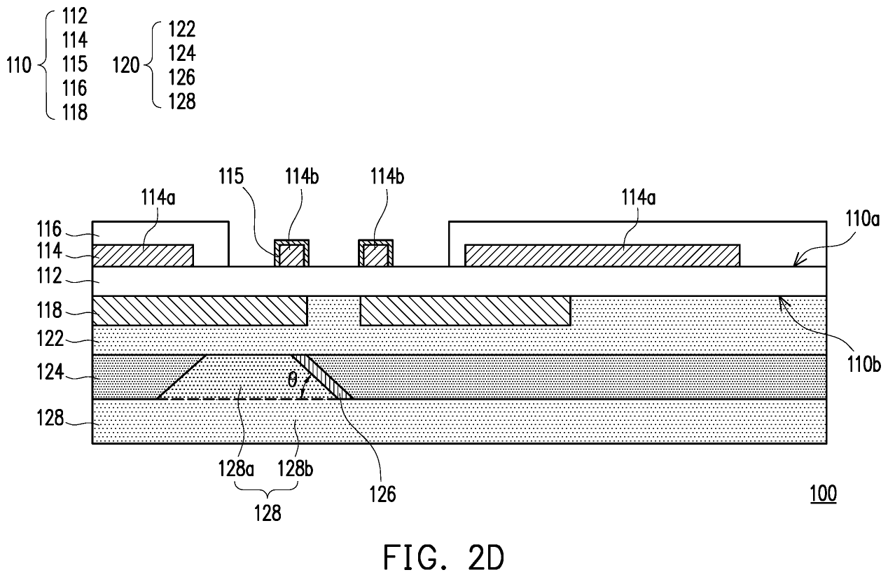

The above only describes the structure of the optical waveguide circuit substrate 100 of the invention, and does not describe a manufacturing method of the optical waveguide circuit substrate 100 of the invention. Therefore, the structure of the optical waveguide circuit substrate 100 in FIG. 1 is used as an example below to describe a manufacturing process of the optical waveguide circuit substrate 100 of the invention in detail with reference to FIG. 2A to FIG. 2D.

FIG. 2A to FIG. 2D illustrate schematic cross-sectional diagrams of a manufacturing method of the optical waveguide circuit substrate of FIG. 1. Referring to FIG. 2A at first, a manufacturing method of the optical waveguide circuit substrate 100 of the present embodiment includes that: firstly, a circuit board 100 is provided. In the present embodiment, the circuit board 110 has an upper surface 110a and a lower surface 110b opposite to each other and a plurality of pads 114b disposed on the upper surface 110a. In detail, the circuit board 110 of the present embodiment includes an insulating layer 112 and a patterned circuit layer 114. The insulating layer 112 has the upper surface 110a and the lower surface 110b, and the patterned circuit layer 114 is located on the upper surface 110a of the insulating layer 112, and includes a plurality of conducting circuits 114a and pads 114b. Furthermore, in order to effectively maintain the characteristics of the patterned circuit layer 114, the circuit board 110 of the present embodiment further includes a surface treatment layer 115 and a solder resist layer 116. The surface treatment layer 115 clads the pads 114b, and the solder resist layer 116 clads the conducting circuits 114a, so as to avoid oxidization of the conducting circuits 114a. In addition, in order to improve the structural strength, the circuit board 110 of the present embodiment further includes a supporting layer 118. The supporting layer 118 is disposed on the lower surface 110b of the insulating layer 112. As shown in FIG. 1, the supporting layer 118 of the present embodiment further has an opening 118c. An orthographic projection of the opening 118c on the upper surface 110a is located between the pads 114b. The circuit board 110 may be, for example, a flexible circuit board.

Secondly, referring to FIG. 2B, a first cladding layer 122 is formed on the lower surface 110b of the circuit board 110. A material of the first cladding layer 122 is, for example, an insulating material. In an embodiment, the material of the first cladding layer 122 may be, for example, a photoresist material. A method for forming the first cladding layer 122 is, for example, a coating method, but is not limited thereto.

Referring to FIG. 2C, a core layer 124 is formed on the first cladding layer 122. A material of the core layer 124 is, for example, an insulating material. A method for forming the core layer 124 is, for example, a coating method, but is not limited thereto. In an embodiment, the material of the first cladding layer 122 is different from that of the core layer 124. Therefore, the first cladding layer 122 and the core layer 124 have different optical refractive indexes. Then, an imprinted opening 124c is formed on the core layer 124 by imprinting. Because the imprinted opening 124c is manufactured by imprinting in the present embodiment, compared with an opening formed by a conventional laser process, the imprinted opening 124c at a specific angle (such as 44 degrees to 46 degrees) may be formed by a simpler process in the present embodiment, which can reduce the manufacturing costs of the optical waveguide circuit substrate 100.

Then, referring to FIG. 2C again, a reflective layer 126 is formed on a sidewall 124s of the imprinted opening 124c. A material of the reflective layer 126 is metal, such as aluminum, but the invention is not limited thereto. A method for forming the reflective layer 126 is, for example, a sputtering method. In comparison to air, a refractive index difference between the imprinted opening 124c formed by imprinting and other materials in the optical waveguide circuit substrate 100 is less obvious. Therefore, the reflective layer 126 is further formed on the sidewall 124s of the imprinted opening 124c, and the optical signal may have a good total reflection to improve the later photoelectric conversion efficiency.

Finally, referring to FIG. 2D, a second cladding layer 128 is formed on the core layer 124. The second cladding layer 128 fills the imprinted opening 124c. A material of the second cladding layer 128 is an insulating material or a photoresist material, and a method for forming the core layer 124 is, for example, a coating method. In an embodiment, the material of the second cladding layer 128 may be the same as or different from the material of the first cladding layer 122. Preferably, the optical refractive index of the first cladding layer 122 and the optical refractive index of the second cladding layer 128 may be different from the optical refractive index of the core layer 124, so as to ensure that the optical signal may generate the total reflection in the core layer 124 via the reflection of the reflective layer 126. The manufacturing of the optical waveguide circuit substrate 100 has been completed.

Based on the above, the first portion of the second cladding layer of the optical waveguide circuit substrate of the invention fills the imprinted opening of the first cladding layer, the reflective layer is located between the core layer and the first portion of the second cladding layer, and the angle between the reflective layer and the connection surface is in a range from 44 degrees to 46 degrees. Therefore, an optical signal subsequently entering via a space between the pads of the circuit board may be transmitted outward through total reflection in the core layer via the reflective layer. In addition, because the imprinted opening is manufactured by imprinting in the invention, compared with an opening formed by a conventional laser process, the optical waveguide circuit substrate of the invention is easy to manufacture and high in yield and can effectively reduce the production costs.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

What is claimed is:

1. An optical waveguide circuit substrate, comprising:
a circuit board, comprising an upper surface and a lower surface opposite to each other, and a plurality of pads disposed on the upper surface; and
an optical waveguide structure, disposed on the circuit board and located on the lower surface, wherein the optical waveguide structure comprises:
a first cladding layer;
a second cladding layer, comprising a first portion and a second portion;
a core layer, located between the first cladding layer and the second cladding layer and comprising an imprinted opening, wherein the first cladding layer is located between the circuit board and the core layer, an aperture of the imprinted opening gradually increases from the first cladding layer to the second cladding layer, the first portion of the second cladding layer fills the imprinted opening and comprises a connection surface, the second portion of the second cladding layer is in contact with the connection surface and covers a bottom surface of the core layer, and the connection surface is flush with the bottom surface; and
a reflective layer, located between the core layer and the first portion of the second cladding layer, wherein an angle between the reflective layer and the connection surface is in a range from 44 degrees to 46 degrees, and an orthographic projection of the reflective layer on the upper surface of the circuit board is located between the plurality of pads.

2. The optical waveguide circuit substrate according to claim 1, wherein the circuit board comprises:
at least one insulating layer; and
at least one patterned circuit layer, comprising a plurality of conducting circuits and the plurality of pads, wherein the insulating layer is located between the patterned circuit layer and the optical waveguide structure.

3. The optical waveguide circuit substrate according to claim 2, wherein the circuit board further comprises:
a solder resist layer, cladding the plurality of conducting circuits; and
a surface treatment layer, cladding the plurality of pads.

4. The optical waveguide circuit substrate according to claim 2, wherein the circuit board further comprises:
a supporting layer, disposed between the insulating layer and the optical waveguide structure, wherein a first side of the supporting layer is retracted by a distance relative to a second side of the first cladding layer.

5. The optical waveguide circuit substrate according to claim 4, wherein the supporting layer comprises an opening, and an orthographic projection of the opening on the upper surface is located between the plurality of pads.

6. The optical waveguide circuit substrate according to claim 5, wherein the first cladding layer fills the opening and covers part of the insulating layer.

7. The optical waveguide circuit substrate according to claim 5, wherein the orthographic projection of the opening on the upper surface and an orthographic projection of the imprinted opening on the upper surface partially overlap.

8. The optical waveguide circuit substrate according to claim 1, wherein an optical refractive index of the first cladding layer and an optical refractive index of the second cladding layer are different from an optical refractive index of the core layer.

9. The optical waveguide circuit substrate according to claim 1, wherein part of the second cladding layer is in direct contact with the first cladding layer.

10. The optical waveguide circuit substrate according to claim 1, wherein a cross-sectional shape of the first portion of the second cladding layer comprises an isosceles trapezoid.

11. A manufacturing method of an optical waveguide circuit substrate, comprising:
providing a circuit board, wherein the circuit board comprises an upper surface and a lower surface opposite to each other, and a plurality of pads disposed on the upper surface;
forming a first cladding layer on the lower surface of the circuit board;
forming a core layer on the first cladding layer;
forming an imprinted opening on the core layer by imprinting, wherein an aperture of the imprinted opening gradually increases from the first cladding layer to a direction away from the first cladding layer;
forming a reflective layer on a sidewall of the imprinted opening, wherein an orthographic projection of the reflective layer on the upper surface of the circuit board is located between the plurality of pads; and
forming a second cladding layer on the core layer, wherein the second cladding layer comprises a first portion and a second portion, the first portion fills the imprinted opening and comprises a connection surface, the second portion is in contact with the connection surface and covers a bottom surface of the core layer, the connection surface is flush with the bottom surface, the reflective layer is located between the core layer and the first portion of the second cladding layer, and an angle between the reflective layer and the connection surface is in a range from 44 degrees to 46 degrees.

12. The manufacturing method of the optical waveguide circuit substrate according to claim 11, wherein the circuit board comprises:
at least one insulating layer; and
at least one patterned circuit layer, comprising a plurality of conducting circuits and the plurality of pads, wherein the insulating layer is located between the patterned circuit layer and the optical waveguide structure.

13. The manufacturing method of the optical waveguide circuit substrate according to claim 12, wherein the circuit board further comprises:
a solder resist layer, cladding the plurality of conducting circuits; and
a surface treatment layer, cladding the plurality of pads.

14. The manufacturing method of the optical waveguide circuit substrate according to claim 12, wherein the circuit board further comprises:
a supporting layer, disposed between the insulating layer and the optical waveguide structure, and a first side of the supporting layer is retracted by a distance relative to a second side of the first cladding layer.

15. The manufacturing method of the optical waveguide circuit substrate according to claim 14, wherein the supporting layer comprises an opening, and an orthographic projection of the opening on the upper surface is located between the plurality of pads.

16. The manufacturing method of the optical waveguide circuit substrate according to claim 15, wherein the first cladding layer fills the opening and covers part of the insulating layer.

17. The manufacturing method of the optical waveguide circuit substrate according to claim 15, wherein the orthographic projection of the opening on the upper surface and an orthographic projection of the imprinted opening on the upper surface partially overlap.

18. The manufacturing method of the optical waveguide circuit substrate according to claim 11, wherein an optical refractive index of the first cladding layer and an optical refractive index of the second cladding layer are different from an optical refractive index of the core layer.

19. The manufacturing method of the optical waveguide circuit substrate according to claim 11, wherein part of the second cladding layer is in direct contact with the first cladding layer.

20. The manufacturing method of the optical waveguide circuit substrate according to claim 11, wherein a cross-sectional shape of the first portion of the second cladding layer comprises an isosceles trapezoid.
